(19) United States
(12) Patent Application Publication
(10) Pub. No.: US 2010/0271991 A1
(43) Pub. Date: Oct. 28, 2010

(54) WIRELESS COMMUNICATION APPARATUS, WIRELESS COMMUNICATION METHOD, COMPUTER PROGRAM, AND WIRELESS COMMUNICATION SYSTEM

(76) Inventors: Ryota Kimura, Tokyo (JP); Kazuyuki Sakoda, Tokyo (JP); Yuichi Morioka, Tokyo (JP); Ryo Sawai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/757,624

(22) Filed: Apr. 9, 2010

(30) Foreign Application Priority Data
Apr. 22, 2009 (JP) P2009-104253

(51) Int. Cl. H04W 8/00

(52) U.S. Cl. 370/310

(57) ABSTRACT

A wireless communication apparatus includes a packet-generating section and a transmission section. The generating section is provided for generating a packet and characteristically performing symbol repetition on a preamble of the packet. The transmission section is provided for transmitting the packet subjected to the symbol repetition as a wireless signal.

### BACKGROUND OF THE INVENTION

1. Field of the Invention

The present invention relates to a wireless communication apparatus, a wireless communication method, a computer program, and a wireless communication system. In particular, the present invention relates to a wireless communication apparatus, a wireless communication method, a computer program, and a wireless communication system, where symbol repetition is characteristically performed to a packet on the transmission side and the results of detecting the characteristics of the symbol repetition are used on the reception side to realize stable communication.

2. Description of the Related Art

Technologies for millimeter-wave communications have been developed for major applications of short-range wireless access communications, image transmission systems, simplified communications, automobile anti-collision radars, and so on to increase their uses by realizing high capacity long-haul communication, small-sized low-cost communication devices, and so on. A millimeter wave has a wavelength of 10 mm to 1 mm, corresponding to a frequency of 30 GHz to 300 GHz. For instance, in wireless communications using the 60 GHz, it is possible to assign a channel in GHz and realize very high data communications.

As compared with microwave which has been widely used in technologies of wireless LAN (Local Area Network), millimeter wave is short and extremely linear, allowing the device to transmit a very large amount of information. However, millimeter-wave attenuation occurs notably due to reflection and the wireless communication path may be mainly a direct wave, or at most a single reflection wave. In addition, the millimeter wave has a property in which a wireless signal does not propagate far away because of large propagation loss.

In order to compensate such a flight distance problem of the millimeter wave, it is considered to provide the antenna of a transceiver with directivity to extend a communication distance by directing a transmission beam and a reception beam to the location of a communication party. The directivity of a beam can be controlled by mounting a plurality of antennas on a transmission/reception device and changing the transmission weight or the reception weight of each antenna. In the case of millimeter waves, reflected waves are hardly used but direct waves are important because of the directivity of the beam shape. Thus, beams having a keen directivity may be used for the millimeter waves. Therefore, wireless communication with millimeter wave may be performed after learning the optimal antenna directivity.

For instance, a wireless transmission system having a first communication unit and a second communication unit has been proposed. In this system, the second communication unit uses at least one kind of communication, such as power line communication, optical communication, and sound wave communication, and transmits a signal that defines the directivity of a transmission antenna. Subsequently, after determining the direction of the transmission antenna, the fist communication device using an electric wave of 10 GHz or more allows a receiver (reception section) and a transmitter (transmission section) to carry out the wireless transmission therebetween (e.g., Japanese Patent Nos. 3544891 and 3333117)

In addition, a method for extending a communication distance using antenna directivity has been applied to the wireless PAN using a millimeter-wave band (mmWPAN: millimeter-wave Wireless Personal Area Network), which is the standard thereof based on IEEE 802.15.3c.

### SUMMARY OF THE INVENTION

In the case of wireless communication using a frequency band with a high straightness, omni-directional (non-directional) communication may be carried out before communication directing transmission beams and reception beams to the position of a communication partner, or the like. For example, before communication in which directivity is being controlled, beacons for reporting various kinds of information to the surrounding wireless communication apparatuses may be transmitted with omni directivity.

Omni-directional communication has a gain lower than that of communication in which the directivity thereof is optically set. Therefore, the attenuation of gain due to omni directivity can be compensated by carrying out symbol repetition in a packet transmitted with omni directivity and using the respective symbols being repeated to heighten the gain. However, if the number of times of symbol repetition is determined by carrying out communication between wireless communication apparatuses, an increase in overhead may occur during the desired communication.

Therefore, there are demands of a wireless communication apparatus, wireless communication method, computer program, and a radio communications system, which can realize stable communication in an efficient fashion even if antenna directional gain is not sufficient.

A first embodiment of the present invention is a wireless communication apparatus that includes a packet-generating section generating a packet and characteristically performing symbol repetition on a preamble of the packet, and a transmission section transmitting the packet subjected to the symbol repetition as a wireless signal.

In this embodiment, a packet is generated and symbol repetition is then characteristically performed on the preamble of the generated packet. For example, the characterization of symbol repetition is performed depending on at least one of the type of the packet and antenna-directivity pattern. In addition, symbol repetition may be performed by every symbol or a predetermined symbol unit. The characterization of symbol repetition may change at least one of: the number of times of symbol repetition; a symbol amplitude; a symbol phase; and a complex symbol series. If the symbol repetition is performed on two or more of a preamble, and the header and payload of a packet, the characterization of symbol repetition may be equally performed on the selected items. In addition, the symbol repetition may be performed in time direction and/or in frequency direction. Furthermore, the number of times of symbol repetition may be increased when the characterization of symbol repetition is changed depending on the result of observing the status of electric-wave propagation. Therefore, the packet subjected to the symbol repetition can be transmitted as a wireless signal.

A second embodiment of the present invention is a wireless communication apparatus that includes a reception section receiving a wireless signal, a preamble detector detecting a preamble of a packet obtained by receiving the wireless signal received by the reception section, a packet processing section extracting data next to the preamble from the packet using the result of the preamble detection. In this communication apparatus, the preamble detector detects the characteristic of symbol repetition in the packet and then detects the preamble with reference to the detected characteristic of symbol repetition.

In this embodiment, the correlation value of the symbol repetition in the packet or the correlation value between a previously defined pattern and the packet may be calculated. Then, the calculated correlation value may be compared with a previously defined threshold to detect a preamble. Subsequently, data next to the preamble may be extracted from the packet using the result of the preamble detection and then processed.

A third embodiment of the present is a wireless communication method that includes the steps of: characteristically performing symbol repetition on a preamble of a packet in a packet-generating section; and transmitting the packet subjected to the symbol repetition as a wireless signal from a transmission section.

A fourth embodiment of the present invention is a wireless communication method that includes the steps of: receiving a wireless signal by a reception section; allowing a preamble detector to detect the characteristic of symbol repetition in a packet obtained by receiving the wireless signal by the reception section, followed by detecting the preamble based on the detected characteristic of the symbol repetition; and allowing a packet processing section to extract data subsequent the preamble from the packet using the result of the preamble detection.

A fifth embodiment of the present invention is a computer program that allows a computer to execute communication processing on a communication apparatus having a communication section for wireless communication. The computer program allows the computer to be functioned as a device or means which is allowable to characteristically perform symbol repetition on a preamble of a packet, and a device or means which is allowable to transmit the packet subjected to the symbol repetition as a wireless signal from the communication section.

A sixth embodiment of the present invention is a computer program that allows a computer to execute communication processing on a communication apparatus having a communication section for wireless communication. The computer program allows the computer to be functioned as a device or means which is allowable to transmit a wireless signal by the communication section; a device or means which is allowable to detect the characteristic of symbol repetition in a packet obtained by receiving the wireless signal by the communication section, followed by detecting the preamble based on the detected characteristic of the symbol repetition; and a device or means which is allowable to detect data next to the preamble from the packet using the result of the preamble detection.

A seventh embodiment of the present invention is a wireless communication system that includes a first wireless communication apparatus transmitting a packet and a second wireless communication apparatus receiving the packet. Here, the first wireless communication apparatus includes a packet-generating section characteristically performing symbol repetition on a preamble of the packet, and transmission section transmitting the packet subjected to the symbol repetition as a wireless signal. In addition, the second wireless communication apparatus includes a reception section receiving the wireless signal, a preamble detector detecting the characteristic of symbol repetition in a packet obtained by receiving the wireless signal by the communication section, followed by detecting the preamble based on the detected characteristic of the symbol repetition, and packet processing section extracting data next to the preamble from the packet using the result of the preamble detection.

The computer program according to the embodiment of the present invention may be provided through a storage medium or a communication medium, which can be offered in a computer-readable format. The storage medium may be an optical disk, magnetic disk, or a semiconductor memory and the communication medium may be a network. Program-based processing can be realized on a computer system by providing the program in a computer-readable format.

According to any embodiment of the present invention, symbol repetition is characteristically performed on the preamble of a packet being generated and the resulting packet is then transmitted as a wireless signal. Subsequently, the characteristic of the symbol repetition on the packet obtained by receiving the wireless signal and the preamble is then detected based on the characteristic of the detected symbol repetition.

Therefore, an increase in overhead can be prevented as the data of header or payload can be extracted on the reception side even without giving information about symbol repetition performed on the transmission side. In addition, even if there is no sufficient antenna directional gain, the symbol repetition can heighten the gain and stable communication can be thus realized.

### BRIEF DESCRIPTION OF THE DRAWINGS

FIG. 1 is a diagram illustrating the configuration of a wireless communication apparatus;

FIG. 2 is a diagram illustrating an exemplary format of a packet;

FIG. 3 is a diagram illustrating the configuration of a preamble detector;

FIG. 4 is a diagram illustrating an exemplary configuration of a preamble detector capable of concurrently performing preamble detection;

FIG. 5 is a diagram illustrating an exemplary packet format before the symbol repetition;

FIG. 6 is a diagram illustrating a case where symbol repetition is performed on a preamble with respect to each predetermined symbol unit;

FIG. 7 is a diagram illustrating a case where symbol repetition is performed on a preamble with respect to each symbol;

FIG. 8 is a diagram illustrating a case where symbol repetition is performed on a preamble using a complex coefficient;

FIG. 9 is a diagram illustrating a case (part 1) where a complex symbol series is used for symbol repetition on a preamble;

FIG. 10 is a diagram illustrating a case (part 2) where a complex symbol series is used for symbol repetition on a preamble;

FIG. 11 is a diagram illustrating a case where the type of basic pattern of symbol repetition on a preamble is changed;

FIG. 12 is a diagram illustrating a case (part 1) where the characterization of symbol repetition is equally performed on both a preamble and a payload;

FIG. 13 is a diagram illustrating a case (part 2) where the characterization of symbol repetition is equally performed on both a preamble and a payload;

FIG. 14 is a diagram illustrating a case where symbol repetition is performed on a payload in time direction;

FIG. 15 is a diagram illustrating a case where symbol repetition is performed on a payload in time direction;

FIG. 16 is a diagram illustrating the configuration of a wireless communication system.

FIG. 17 is a diagram illustrating communication procedures from beacon transmission to completion of data reception;

FIG. 18 is a diagram illustrating communication procedures for symbol repetition in directivity training; and

FIG. 19 is a diagram illustrating the configuration of an information apparatus.

### DESCRIPTION OF THE PREFERRED EMBODIMENTS

Hereinafter, embodiments of the present invention will be described with reference to the attached drawings. Where symbol repetition is performed in a packet to be transmitted with omni directivity to compensate gain attenuation due to omni directivity in omni-directional (non-directional) communication, an overhead will become large when the number of times of symbol repetition is determined by performing communication between wireless communication apparatuses.

In consideration of such a problem, any embodiment of the present invention prevents an increase in overhead by allowing a reception side to decode the symbol repetition carried out on a transmission side even without acquisition of the information about the symbol repetition by preliminary communication. In addition, any embodiment of the present invention increases the gain by symbol repetition to realize stable communication even if an antenna directional gain is insufficient. The embodiments will be described in the following order:

1. Configuration of wireless communication apparatus

2. Operation of symbol repetition

3. Operation of wireless communication apparatus

### <1. Configuration of Wireless Communication Apparatus>

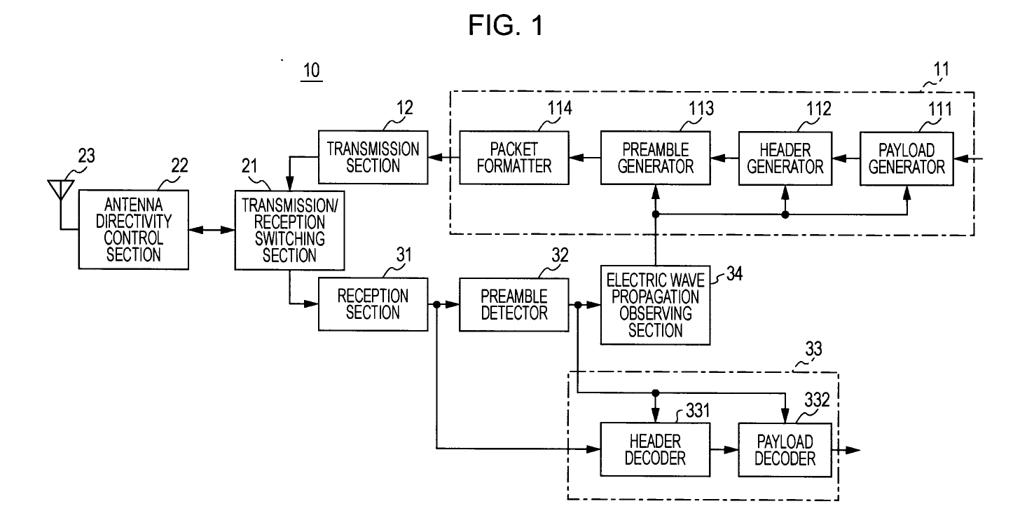

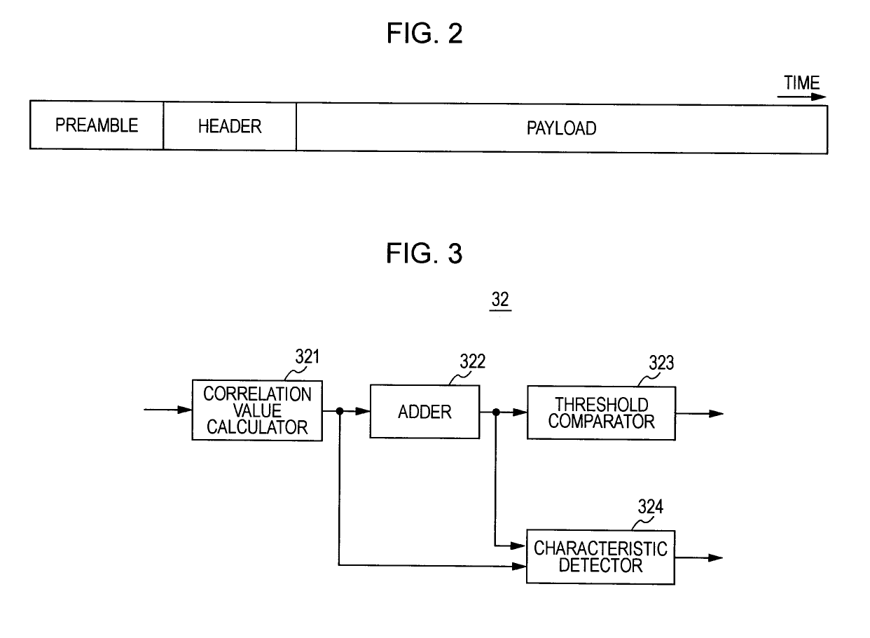

FIG. 1 is a diagram illustrating the configuration of a wireless communication apparatus. A wireless communication apparatus 10 includes a packet-generating section 11, a transmission section 12, a transmission/reception switching section 21, a directivity control section 22, and an antenna 23. The wireless communication apparatus 10 further includes a reception section 31, a preamble detector 32, a packet-processing section 33, and a electric-wave propagation observing section 34. The packet-generating section 11 includes a payload generator 111, a header generator 112, a preamble generator 113, and a packet formatter 114. The packet processing section 33 includes a head decoder 331 and a payload decoder 332. The payload generator 111 of the packet-generating section 11 generates the payload of a packet using transmitted data. The header generator 112 generates a header using the information about the head of the packet to be transmitted. The preamble generator 113 generates the preamble of the packet to be transmitted. The packet formatter 114 generates a packet of a predetermined format using the generated payload as well as the generated head and preamble. For example, as shown in FIG. 2, the packet is generated in a format the preamble is located at the head of the packet, followed by the head and the payload in this order.

Furthermore, the packet-generating section 11 characteristically carries out symbol repetition on at least one of the preamble, header, and payload of the packet. For example, the packet-generating section 11 performs symbol repetition for every symbol or for every predetermined symbol unit. In addition, the packet-generating section 11 alters at least any of the number of times of symbol repetition, a symbol amplitude, a symbol phase, and a complex symbol series. Furthermore, the packet-generating section 11 characteristically carries out symbol repetition depending on at least one of the type of the packet and the antenna-directivity pattern.

The transmission section 12 performs a modulation process or the like on the packet of a predetermined format generated from the packet formatter 114 and then generates a sending signal of a predetermined communication mode. The transmission/reception switching section 21 supplies the sending signal generated from the transmission section 12 to the directivity control section 22. The directivity control section 22 makes the directivity of the antenna 23 into omni directivity or the directivity of a desired beam pattern, followed by transmitting from the antenna 23 the sending signal generated from the transmission section 12.

The directivity control section 22 supplies a received signal obtained as a wireless signal received by the antenna 23 while the directivity of the antenna 23 is being set to, for example, omni directivity or the directivity of a desired beam pattern. The transmission/reception switching section 21 supplies the signal received by the antenna 23 to the reception section 31.

The reception section 31 supplies received packet data to the preamble detector 32 and the packet processing section 33, where the received packet data has been obtained by subjecting the received signal to a demodulation process or the like.

The preamble detector 32 performs processing of detecting a preamble from the received packet data. The detection result is output to the packet-processing section 33 and the electric-wave propagation observing section 34. The preamble detector 32 detects the characteristic of symbol repetition in the packet and then detects the preamble based on the characteristic of the detected symbol repetition.

The packet-processing section 33 includes a header decoder 331 and a payload decoder 332. When the preamble detector 32 has detected the preamble, the header decoder 331 decodes a header next to the detected preamble to acquire head information. When the preamble detector 32 has detected the preamble, the payload decoder 332 decodes a payload determined based on this detected preamble and then outputs a data signal. Specifically, when the preamble detector 32 has detected the preamble, the header decoder 331 and the payload decoder 332 decode the header and the payload on the basis of timing-identification signal generated by the preamble detector 32 which is capable of identifying the timing of starting the header and the timing of the payload as described later.

The electric-wave propagation observing section 34 determines an electric-wave propagation environment based on the received signal, and changes the symbol repetition pattern according to an electric-wave propagation environment. For example, the electric-wave propagation observing section 34 is designed to enhance the gain when the received power of the received signal is small upon detection of the preamble or when a signal-to-noise power ration is not satisfied. That is, the electric-wave propagation observing section 34 increases the number of times of repetition of the preamble in the preamble generator 113.

Referring now to FIG. 3, an exemplary configuration of the preamble detector for symbol repetition on the preamble will be described. The preamble detector performs the detection of preamble by calculating a correlation value of symbol repetition in the packet or calculating a correlation value of a predetermined pattern and the packet, and then making a comparison between the calculated correlation value and a predetermined threshold. The preamble detector 32 includes a correlation value calculator 321, an adder 322, a threshold comparator 323, and a characteristic detector 324.

The correlation value calculator 321 calculates a correlation value for repeated preambles in the received packets. For example, a correlation value between the basic pattern or the complex symbol series, which are known pattern or sequence, and the preamble pattern or a complex symbol series in the received packet is calculated. In addition, the correlation value calculator 321 may calculate a correlation value between preamble patterns repeated within the received packet, or between complex symbol series.

The adder 322 adds the correlation values calculated by the correlation value calculator 321 so that symbol repetition can increase the gain.

The threshold comparator 323 compares a predetermined threshold value with the result of the addition performed by the adder 322. Then, the threshold determines that the preamble has been detected when the result exceeds the threshold.

The characteristic detector 324 detects the characteristic of the repetition pattern based on the output from the correlation value calculator or the adder. Furthermore, the characteristic detector 324 generates a timing-identification signal that makes possible to identify the timing of starting the header or the payload on the basis of the detected characteristic. Then, the characteristic detector 324 outputs the timing-identification signal to the header decoder 331 or the payload decoder 332. For example, when performing symbol repetition, the characteristic detector 324 makes a rule in advance between wireless communication apparatuses with respect to whether symbol repetition should be performed by changing any of amplitude, phase, and the used complex symbol series. Then, the characteristic detector 324 identifies the repetition pattern based on the output from the correlation value calculator or the adder. Furthermore, the characteristic detector 324 determines which one of the identified repetition patterns and then generates a timing-identification signal based on the result of the detection.

Furthermore, the detection of a preamble is not limited to only one basic pattern or complex symbol series. For detecting the preamble, a plurality of different basic patterns or complex symbol series may be used for parallely carrying out the preamble detection procedures with the respective basic patterns or complex symbol series.

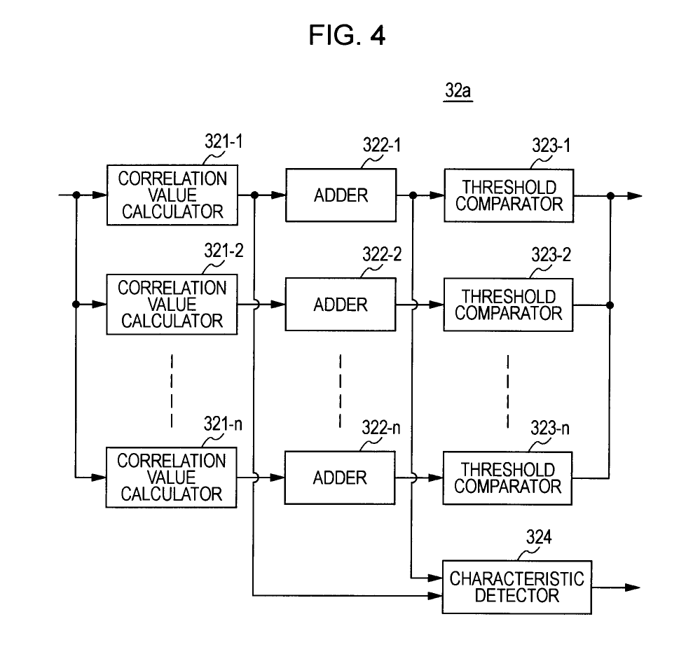

FIG. 4 is a diagram illustrating an exemplary configuration of a preamble detector capable of concurrently performing preamble detection. In FIG. 4, correlation value calculators 321-1 to 321-n calculate preamble patterns in a received packet or a correlation value with a complex symbol series using their respective basic patterns or complex symbol series, which are different from one another.

The adder 322-1 adds the correlation values calculated by the calculator 321-1 in a manner similar to that of the above adder 322. In addition, the adders 322-2 to 322-n add correlation values calculated by the correlation value calculators 321-2 to 321-1, respectively.

A threshold comparator 323-1 compares the result of the addition performed by the adder 322-1 with a predetermined threshold in a manner similar to that of the above threshold comparator 323. Then, the preamble is identified when the result exceeds the threshold. In addition, the threshold comparators 323-2 to 323-n compare the results of the addition performed by the adders 322-2 to 322-n with predetermined thresholds. Then, the preamble is identified when the result exceeds the threshold. Here, threshold values used in the threshold comparators 323-1 to 323-n may be equal to one another. Alternatively, threshold values may be defined and used with reference to the basic patterns or complex symbol series employed in the correlation value calculators 321-1 to 321-n.

The characteristic detector 324 detects the characteristics of repetition patterns based on the outputs from the respective correlation value calculators 321-1 to 321-n or adders 322-1 to 322-n. The characteristic detector 324 generates a timing-identification signal that makes possible to identify the timing of starting the header or the payload, and then outputs the signal to the header decoder 331 or the payload decoder 332.

Thus, it is possible to detect a preamble promptly by parallely performing the preamble detection of the basic pattern or the complex symbol series even if the basic pattern or the complex symbol series is changed as a characteristic of the symbol repetition.

### <2. Operation of Symbol Repetition>

Next, the operation of symbol repetition will be described. The symbol repetition is performed using a change in characteristic of the repetition. Here, the characteristic of the repetition may be at least one of the number of times of symbol repetition, the amplitude or phase of the symbol, a complex coefficient by which the symbol is multiplied, a complex symbol series, and other similar matters. Thus, the symbol repetition is performed while changing the level of such a characteristic.

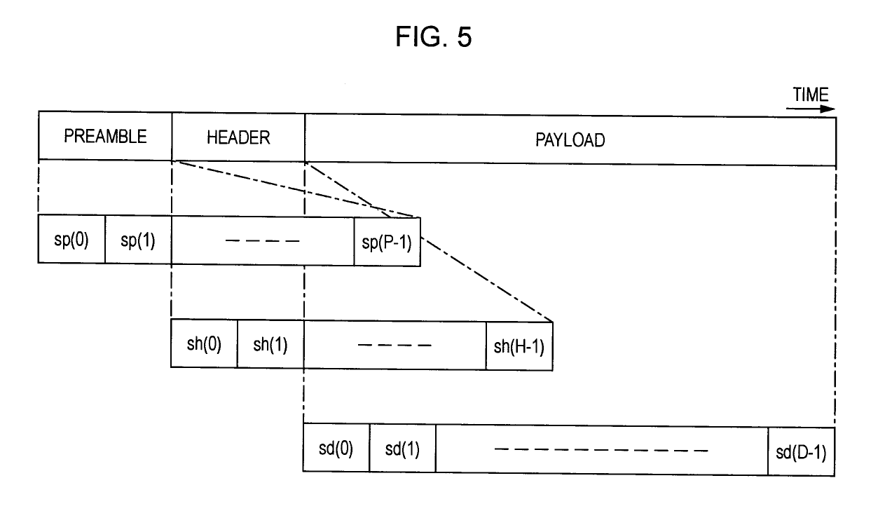

FIG. 5 is a diagram illustrating an exemplary packet format before the symbol repetition. A packet includes a preamble, a header, and a payload.

In the preamble, the number of symbols is defined as “P”. Thus, for example, there are complex symbols, sp (0) to sp (P−1). In the header, the number of symbols is defined as “H”. Thus, for example, there are complex symbols, sh (0) to sh (H−1). In the payload, the number of symbols is defined as “D”. Thus, for example, there are complex symbols, sd (0) to sd (D−1).

Here, a pattern represented by complex symbols sp (0) to sp (P−1) in the preamble is defined as a basic pattern sp. Then, the basic pattern sp is provided as a common knowledge between the wireless communication apparatuses. Thus, as long as the basic pattern sp is commonly recognized between the wireless communication apparatuses, the detection of a packet at the time of reception can be performed easily.

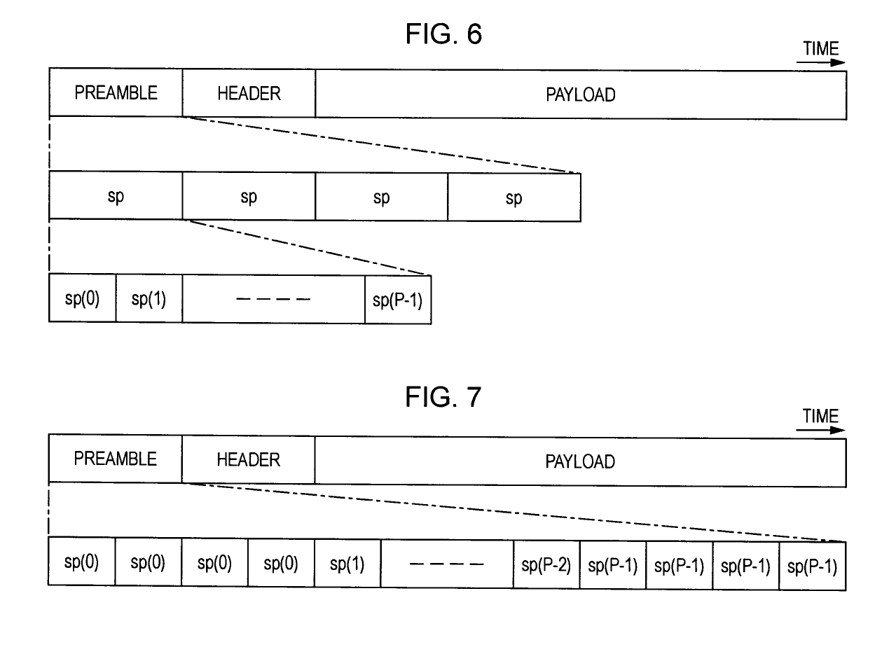

FIGS. 6 to 11 are diagrams illustrating packets where symbol repetition is performed on a preamble.

FIG. 6 is a diagram illustrating a case where symbol repetition is performed on a preamble with respect to a predetermined symbol unit, for example a basic pattern unit. In the case of an example shown in FIG. 6, for example, a basic pattern sp represented by complex symbols sp (0) to sp (P−1) is repeated four times.

Here, it will be appreciated that, if the number of times of repeating the basic pattern sp is “R”, the gain of received power is “10×log(R) decibel (dB)”. Therefore, communication can be stably performed even if it is performed with omni directivity as the repetition of basic pattern sp can result in an increase in gain of received power in the preamble.

FIG. 7 is a diagram illustrating a case where symbol repetition is performed on a preamble with respect to every symbol, for example, every symbol in a basic pattern. In FIG. 7, the basic pattern sp includes complex symbols sp (0) to sp (P−1). For repeating each of symbols in the basic pattern, the respective complex symbols sp (0) to sp (P−1) in the basic pattern sp are repeated. FIG. 7 illustrates an example in which each of the complex symbols sp (0) to sp (P−1) is repeated four times. Therefore, communication can be stably performed even if it is performed with omni directivity as the repetition of each symbol in the basic pattern can result in an increase in gain of received power in the preamble.

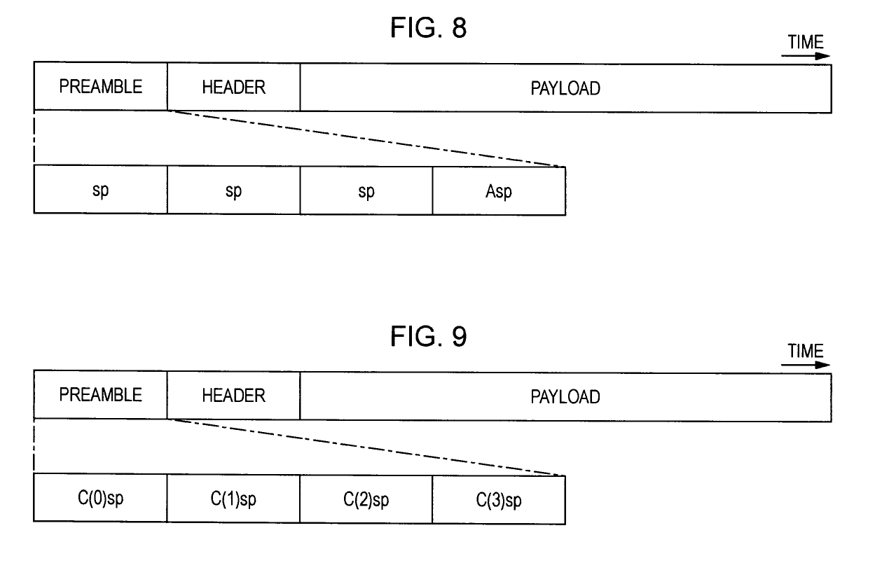

FIG. 8 is a diagram illustrating a case that basic-pattern repetition is performed in the preamble and the last basic pattern of the repetition is multiplied by the complex coefficient. In this FIG. 8, if the basic pattern sp is repeated four times and the last basic pattern of the repetition is multiplied by the complex coefficient A. In this way, as the last basic pattern of the repetition is multiplied by the complex coefficient, the end of the preamble can be recognized even if the basic patterns are equal to one another without depending on the number of times of the repetition. Therefore, the decoding of header or payload can be correctly performed without preliminary communication between wireless communication apparatuses for the information about the number of times of repetition, or the like, before packet communication.

FIG. 9 is a diagram illustrating a case that basic-pattern repetition is performed in the preamble and each of the repeated basic patterns is multiplied by each of the different complex symbol series. Furthermore, in FIG. 9, the basic pattern sp is repeated four times and the fist basic pattern is then multiplied by the complex symbol series C (0), the second basic pattern is then multiplied by the complex symbol series C (1), the third basic pattern is then multiplied by the complex symbol series C (2), and the last basic pattern is then multiplied by the complex symbol series (3).

For multiplying the complex symbol series as described above, if a complex symbol series is already known between wireless communication apparatuses, the complex symbol series can be detected even when the number of times of the repetition is unknown. Thus, from the result of the detection, the number of times of repeating the basic pattern, the turn of the basic pattern in the repetition, and so on can be determined.

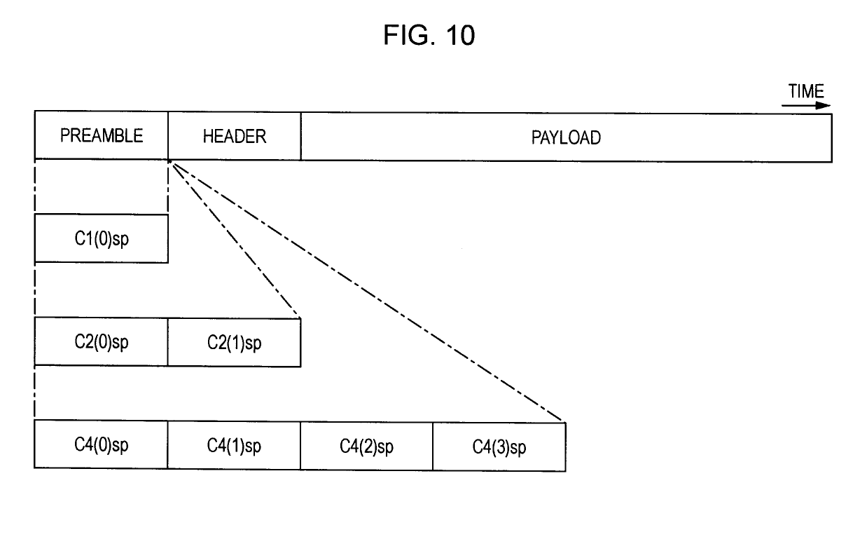

Here, the complex symbol series is selected so that many series with higher orthogonality can be obtained as much as possible. Therefore, by selecting the complex symbol series as described above, for example, the use of different complex symbol series allows the operations of two or more wireless communication systems to be coexistent even if the same space, the same time, and the same frequency channel are used. FIG. 10 illustrates a case that the repetition of basic pattern is repeated on the preamble and the repeated basic patterns are multiplexed by their respective different complex symbol series and the complex symbol series to be multiplexed is changed depending on the number of times of the basic pattern repetition.

For instance, if the number of times of the basic pattern repetition is one, then the complex symbol series C1 (0) is used. In addition, if the number of times of the basic pattern repetition is two, then the complex symbol series C2 (0) and C2 (1) are used. The first basic pattern sp is multiplied by the complex symbol series C2 (0), and the second basic pattern sp is multiplied by the complex symbol series C2 (1). In addition, if the number of times of the basic pattern repetition is four, then the complex symbol series C4 (0) to C4 (3) are used. The first basic pattern sp is multiplied by the complex symbol series C4 (0), and the second basic pattern sp is multiplied by the complex symbol series C4 (1). Furthermore, the third basic pattern sp is multiplied by the complex symbol series C4 (2) and the last basic pattern sp in the repetition is then multiplied by the complex symbol series C4 (3).

In addition, but not shown in the figure, the amplitude and the phase of the complex symbol of the basic pattern can be changed by replacing the complex symbol to be multiplied to the basic pattern. Therefore, the symbol repetition may be characteristically performed by changing the amplitude and the phase of the complex symbol of the basic pattern by replacing the complex symbol to be multiplied to the basic pattern.

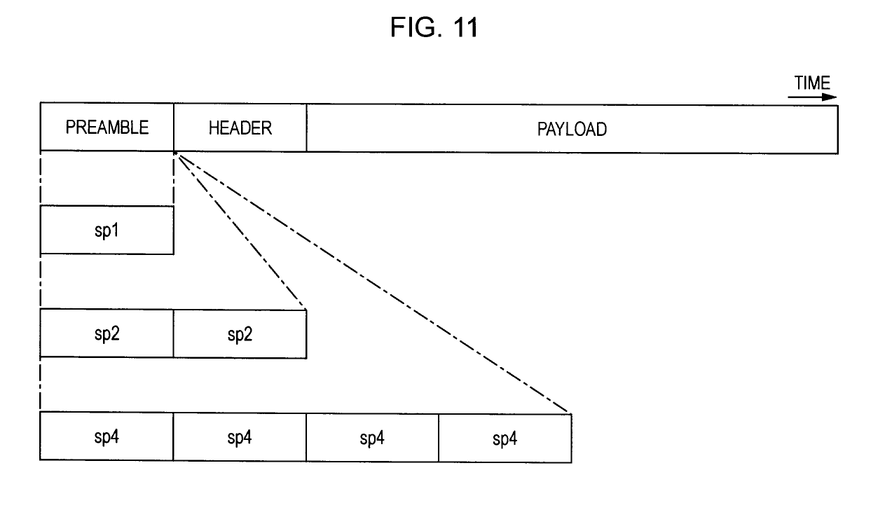

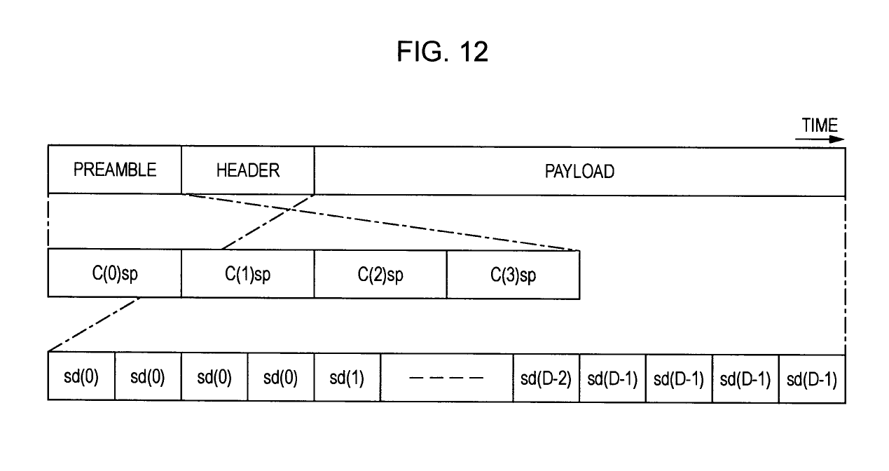

FIG. 11 is a diagram illustrating a case where the type of basic pattern of symbol repetition is changed depending on the number of times of basic pattern repetition on a preamble. For instance, if the number of times of the basic pattern repetition is one, then the basic pattern sp1 is used. If the number of times of the basic pattern repetition is two, then the basic pattern sp2 is used. If the number of times of the basic pattern repetition is three, then the basic pattern sp3 is used. Furthermore, if the number of times of the basic pattern repetition is four, then the basic pattern sp4 is used.

Therefore, if the type of the basic pattern is changed depending on the number of times of the basic pattern repetition, the preamble detector can correctly detect the preamble as a result of an improvement in gain by repetition. In addition, the type of basic pattern can be changed depending on the number of times of basic pattern repetition, the number of the repetition can be determined according to the type of the basic pattern when the preamble is detected. In other words, as the number of times of repetition can be determined, it becomes possible to determine a data length from the head of the preamble to the head of the header or payload. Therefore, the header and the payload can be correctly performed without carrying out communication for information that represents the number of times of repetition between wireless communication apparatuses before packet communication.

As described above, if the basic pattern is repeated on the preamble, the number of the basic patterns can be limited to a finite number, or the finite number of patterns can be notified between wireless communication apparatuses, the processing of preamble detection on a received packet can be simplified.

Alternatively, it may be designed that the symbol repetition is not only performed on the preamble but also performed on at least one of the header and the payload. Thus, by carrying out symbol repetition on the header or the payload, the gain of the header or the payload can be obtained. Thus, the head or the payload can be stably demodulated.

When performing symbol repetition on the header or the payload, any repetition pattern may be employed at will. However, it is desirable to perform the same characterization as that of the repetition pattern applied to the preamble. Therefore, as the repetition pattern has been already recognized at the time of decoding the header or the payload, it is possible to omit the operation of detecting a repetition pattern on the header or the payload. Thus, the gain of the head or the payload can be easily increased.

FIGS. 12 to 15 are diagrams illustrating packets where symbol repetition is performed on both the preamble and the payload.

FIG. 12 illustrates a case that the repetition of basic pattern is repeated on the preamble and the repeated basic patterns are multiplexed by their respective different complex symbol series and the complex symbol series to be multiplexed is changed depending on the number of times of the basic pattern repetition. In addition, it illustrates that symbol repetition is performed on the payload by the same number of times of repetition as that of basic pattern repetition carried out on the preamble. Here, FIG. 12 illustrates a case in which the number of times of repetition is four. For example, if the number of times of repetition on the preamble is four, then the repetition of a predetermined number (D) of complex symbols sd (0) to sd (D−1) can be performed four times on the payload.

Thus, if it is designed to also perform symbol repetition on the payload, the gain of received power in the payload can be increased just as in the case of the repetition of the preamble. Therefore, communication can be stably performed even if it is performed with omni directivity.

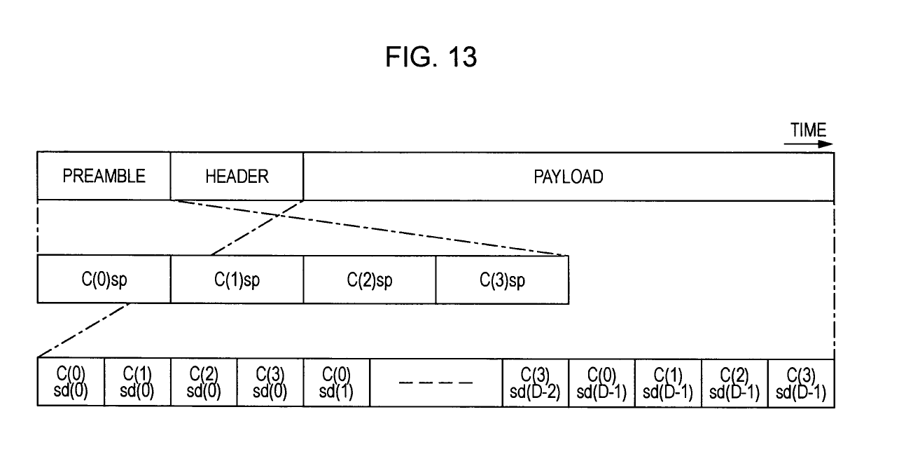

FIG. 13 illustrates a case that the repetition of basic pattern is repeated on the preamble and the repeated basic patterns are multiplexed by their respective different complex symbol series and the complex symbol series to be multiplexed is changed depending on the number of times of the basic pattern repetition. In addition, it illustrates that symbol repetition is performed on the payload by the same number of times of repetition as that of basic pattern repetition carried out on the preamble and the repeated symbols are then multiplied by the complex symbol series in a manner similar to that of the preamble. Here, FIG. 13 illustrates a case in which the number of times of repetition is four. For example, if the number of times of repetition on the preamble is four and the repeated basic patterns are multiplied by the complex symbol series C (0), C (1), C (2), and C (3), then the repetition of a predetermined number (D) of complex symbols sd (0) to sd (D−1) can be performed four times on the payload. In addition, the first repeated symbol is multiplied by complex symbol series C (0). The second repeated symbol is multiplied by complex symbol series C (1), the third repeated symbol is multiplied by complex symbol series C (2), and the third repeated symbol is multiplied by complex symbol series C (3).

Here, as a complex symbol series used for the preamble, the complex symbol series is selected so that many series with higher orthogonally can be obtained as much as possible. Therefore, by selecting the complex symbol series as described above, for example, the use of different complex symbol series allows the operations of two or more wireless communication systems to be coexistent even if the same space, the same time, and the same frequency channel are used.

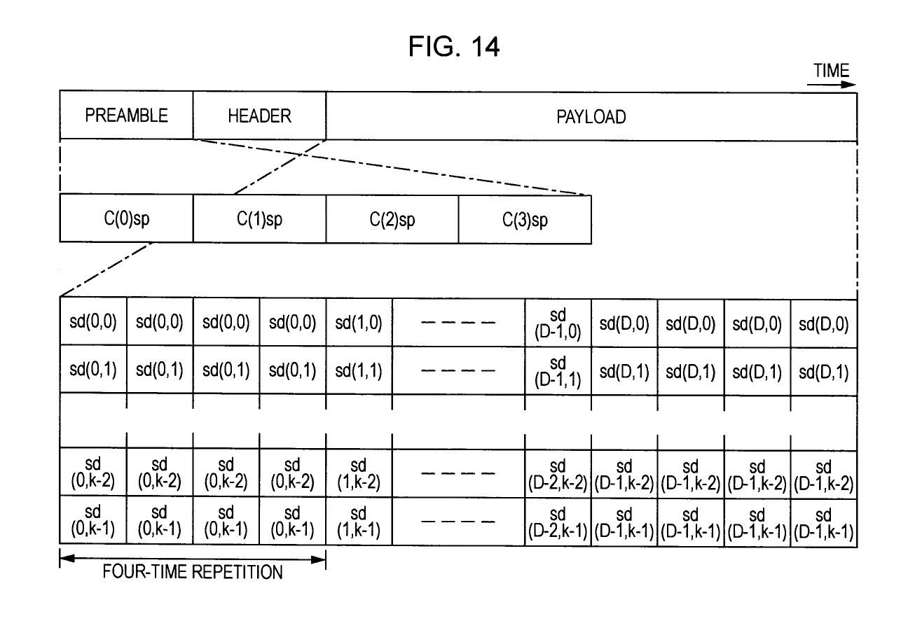

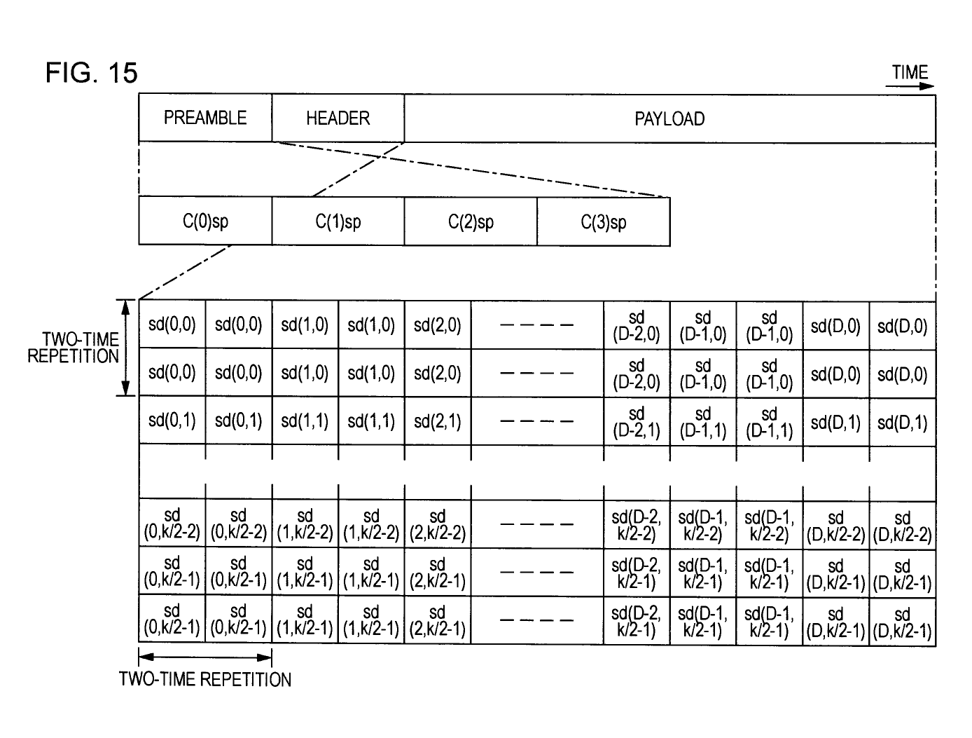

In addition, the symbol repetition may be performed in time direction and/or in frequency direction. FIGS. 14 and 15 represent that symbol repetition is performed in time direction and/or frequency direction when OFDM (Orthogonal Frequency Division Multiplexing) is used as a communication mode. Here, if the number of times of repetition in time direction is represented as “Rt” and the number of times of repetition in frequency direction is represented as “Rf”, then the effectual number of times of repetition “R” can be represented by “R=Rt×Rf”.

FIG. 14 illustrates a case that the repetition of basic pattern is repeated on the preamble and the repeated basic patterns are multiplexed by their respective different complex symbol series and the complex symbol series to be multiplexed is changed depending on the number of times of the basic pattern repetition. In addition, symbol repetition is performed in OFDM on the payload in time direction. In the example shown in FIG. 15, furthermore, the symbol repetition on the preamble is repeated four times and the symbol repetition on the payload is repeated two times in time direction. Furthermore, the number of subcarriers in OFDM is set to “k”.

FIG. 15 illustrates a case that the repetition of basic pattern is repeated on the preamble and the repeated basic patterns are multiplexed by their respective different complex symbol series and the complex symbol series to be multiplexed is changed depending on the number of times of the basic pattern repetition. In addition, symbol repetition is performed in OFDM on the payload in each of time direction and frequency direction. In the example shown in FIG. 14, furthermore, the symbol repetition on the preamble is repeated four times and the symbol repetition on the payload is repeated four times in time direction. In FIG. 15, the symbol repetition is carried out for every subcarrier in frequency direction. Alternatively, it may be performed for every symbol or very predetermined symbol unit just as in the case with the symbol repetition in time direction.

Therefore, the gain can be increased as long as such symbol repetition is performed. Thus, communication can be stably performed even if it is performed with omni directivity. In addition, the detection of the preamble and the distinction of the header and the payload can be easily performed by altering the characteristic of the repetition. Therefore, the decoding of header or payload can be correctly performed without preliminary communication between wireless communication apparatuses for the information about the number of times of repetition, or the like, before packet communication. Furthermore, it is also possible to carry out the symbol repetition with the emphasis on either a time direction or a frequency direction. For example, if it is not desired to make the data length of a packet longer, an increase in number of times of repetition in frequency direction may result in a desired gain even when the number of times of repetition in time direction is small.

### <3. Operation of Wireless Communication Apparatus>

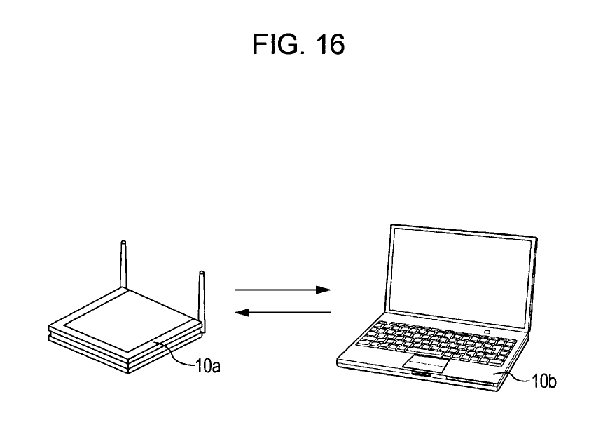

Next, the operation of a wireless communication apparatus to carry out wireless communication using symbol repetition will be described. FIG. 16 illustrates an example of a wireless communication system where, for example, communication using millimeter waves is performed between a wireless communication apparatus 10a and a wireless communication apparatus 10b. Here, each of the wireless communication apparatuses 10a and 10b may have the same configuration as one shown in FIG. 1.

The wireless communication system may control its own directivity. In addition, the wireless communication may have any relationship between packets and antenna directivity in communication. In this case, depending on the directivity and the type of packets, redundant repetition can be prevented by changing the number of times of repetition or the repetition patterns to carry out data communication while avoiding a loss of frame efficiency.

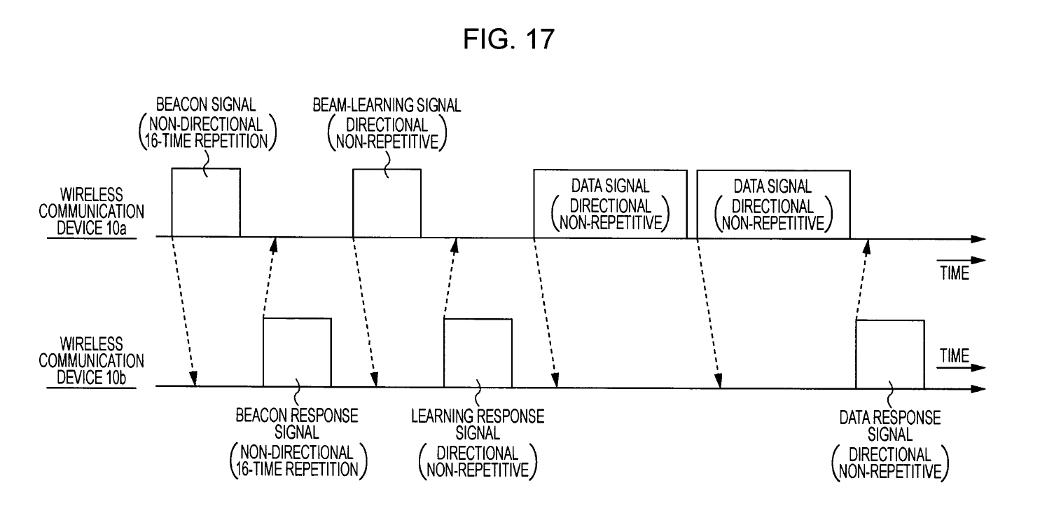

FIG. 17 is a diagram illustrating communication procedures from beacon transmission to completion of data reception between the wireless communication apparatuses 10a and 10b. Beacons are used for notifying information for wireless communication to the surrounding wireless communication apparatuses and mostly transmitted with omni directivity. Therefore, the wireless communication apparatus 10a transmits a beacon with omni directivity (indirectivity). Symbol repetition may be performed in stable with respect to beacon. Thus, for example, the symbol repetition may be performed 16 times. The wireless communication apparatus 10b transmits a beacon response with omni directivity (indirectivity) as a response to the reception of beacon. Likewise, in beacon response, symbol repetition may be performed for stable reception of beacon. Thus, for example, the symbol repetition may be performed 16 times.

Next, the wireless communication apparatus 10a detects another wireless communication apparatus 10b to communicate with each other and then performs directivity training for selecting an optimal beam pattern of an antenna 23 to realize high-speed data communication using millimeter wavers or the like. In the directivity training, the directivity can be sequentially changed to transmit a beam-learning signal. An optimal beam pattern is set based on the directivity training response from the wireless communication apparatus 10b. In addition, for example, the wireless communication apparatus 10b transmits a response signal in the direction in which received power becomes the maximum when a beam-learning signal is received. In the directivity training, for example, symbol repetition is not performed because communication is performed after setting up the directivity.

Thus, the directivity training is performed and the determination of an optimal beam pattern is then completed, followed by transmission of data from the wireless communication apparatus 10a using the defined beam pattern. On the other hand, the wireless communication apparatus 10b makes a response upon reception of data. In addition, as the communication is performed with an optimal directivity, the data communication does not desire symbol repetition.

Consequently, data communication can be performed without redundant repetition while avoiding a loss of frame efficiency.

Furthermore, when two or more directivity patterns are used or the directivity pattern is gradually trained, the number of times of repetition or the repetition pattern may be changed depending on each of the directivity patterns.

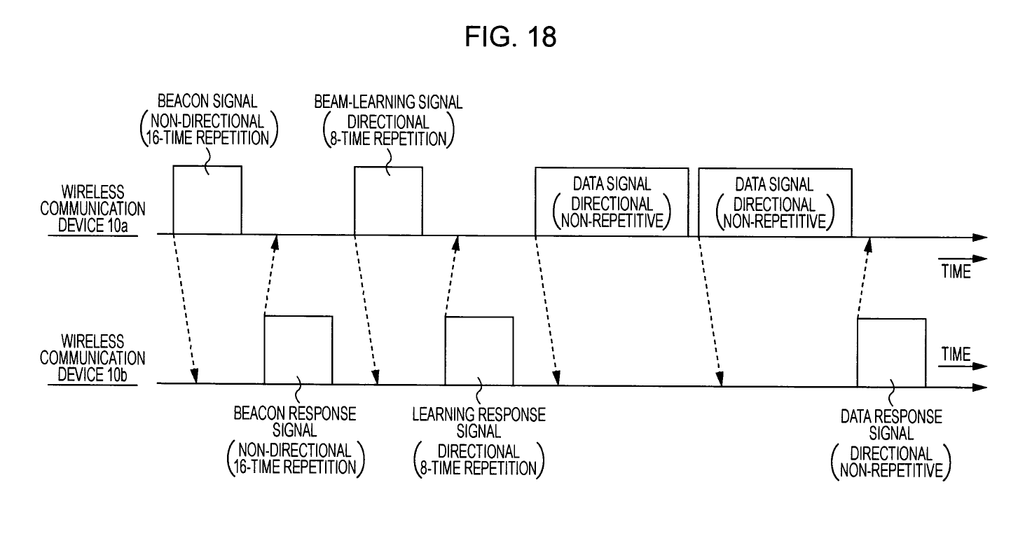

FIG. 18 is a diagram illustrating communication procedures for symbol repetition in directivity training. The wireless communication apparatus 10a transmits a beacon with omni directivity (indirectivity). Symbol repetition may be performed in stable with respect to beacon. Thus, for example, the symbol repetition may be performed 16 times. The wireless communication apparatus 10b transmits a beacon response with omni directivity (indirectivity) as a response to the reception of beacon. Likewise, in beacon response, symbol repetition may be performed for stable reception of beacon. Thus, for example, the symbol repetition may be performed 16 times.

Next, the wireless communication apparatus 10a detects another wireless communication apparatus 10b to communicate with each other and then performs directivity training for selecting an optimal beam pattern of an antenna 23 to realize high-speed data communication using millimeter wavers or the like.

In the directivity training, the range of selecting directivity patterns may be narrowed to some extent because an appropriate beam pattern should be selected while observing the state of reception for every antenna-directivity pattern. Therefore, in the wireless communication apparatus 10a, for example, the symbol repetition may be performed 8 times to stably receive a beam-learning signal. In addition, in the wireless communication apparatus 10b, for example, the symbol repetition may be performed 8 times for directivity training response.

Furthermore, when two or more directivity patterns are used or the directivity pattern is gradually trained, the number of times of repetition or the repetition pattern may be changed depending on each of the directivity patterns.

Thus, the directivity training is performed and the determination of an optimal beam pattern is then completed, followed by transmission of data from the wireless communication apparatus 10a using the defined beam pattern. On the other hand, the wireless communication apparatus 10b makes a response upon reception of data. In addition, as the communication is performed with an optimal directivity, the data communication does not desire symbol repetition.

Consequently, in the directivity training, the range of selecting antenna-directivity patterns may be narrowed. Thus, even if the number of repetition is smaller than that of the omni directivity, beam-learning signals and response signals can be stably received. The antenna-directivity pattern is set to an optimal state after the directivity training. Thus, data communication can be stably performed even if the repetition is not performed. Consequently, by changing the number of times of repetition or the repetition pattern depending on the packet type, data communication without a loss of frame efficiency can be performed.

Furthermore, the number of times of repetition or the repetition pattern can be changed by the status of electric-wave propagation. Thus, communication can be performed further stably. For example, when the status of eclectic-wave propagation is poor in the electric-wave propagation observing section 34, an increase in gain is attained by increasing the number of times of symbol repetition. In contrast, when the status of eclectic-wave propagation is good, the number of times of symbol repetition may be lowered to prevent the gain from increasing more than necessary. Consequently, data communication can be performed depending on the state of electric-wave propagation while avoiding a loss of frame efficiency.

The characteristic of symbol repetition detects the characteristic of symbol repetition and the decoding of header and payload can be then controlled depending on the detected characteristic even if the characteristic of symbol repetition is changed depending on packet class or the state of electric-wave propagation. Therefore, data communication without a loss of frame efficiency can be performed without preliminary communication between wireless communication apparatuses for the information about the number of times of repetition, or the like, before packet communication.

Wireless communication procedures may be different from those shown in FIG. 17 and FIG. 18. In addition, the symbol-repeating packet types and the antenna-directivity patterns are not limited to those shown in FIG. 17 and FIG. 18. Alternatively, the symbol-repeating packet types and the antenna-directivity patterns may be defined depending on the status, environment, or the like at the time of carrying out wireless communication.

Furthermore, the wireless communication apparatus may be any of portable information devices, such as a computer apparatus, a cell phone, and a personal digital assistant (PDA); information apparatus, such as a portable music player and a game machine; and a wireless communication module mounted on home electric appliances, such as a television receiving set.

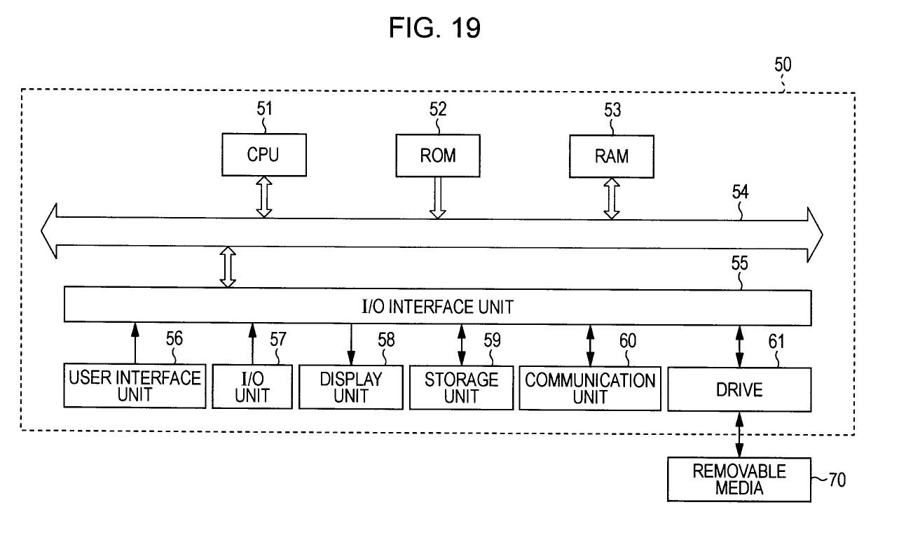

FIG. 19 illustrates an exemplary configuration of an information apparatus 50 on which a wireless communication apparatus is mounted as a module. A central processing unit (CPU) 51 executes programs stored in a read only memory (ROM) 52 and a hard disk drive (HDD) 61 under program execution environment provided by an operating system (OS). For example, it may be realized such that the CPU 51 executes a certain program on synchronous processing of received packets or part thereof.

The ROM 52 stores program codes such as those of the power on self test (POST) and the basic input/output system (BIOS). In addition, a random access memory (RAM) 53 is used for loading the program stored in the ROM 52 or the hard disk drive (HDD) 61 onto the CPU 51 to execute the program or used for temporarily holding the work data of the program under execution. These structural components are connected to one another through a local bus 54 directly linked with a local pin of the CPU 51.

The local bus 54 is also connected to an I/O interface unit 55. The I/O interface unit 55 is connected to an user interface unit 56, an I/O unit 57, a display unit 58, a recording unit 59, a communication unit 60, and a drive 61.

The user interface unit 56 includes pointing devices, such as a key board and a mouse, and so on to generate operation signals based on the user's operation. The I/O unit 57 is an interface for outputting and inputting various data or the like between the apparatus and the external instruments. The display unit 58 may be a liquid crystal display (LCD), a cathode ray tube (CRT), or the like and displays various kinds of information in text or image. The storage unit 59 includes a hard disk drive (HDD) or the like. The storage unit 59 is used for installation of programs to be executed by the CPU 51, such as an operating system and various applications, and also used for storing data files and so on.

The communication unit 60 is a wireless communication interface including a wireless communication apparatus as a module. The communication unit 60 acts as an access point or a terminal station in infrastructure mode or acting in ad-hoc mode to execute wireless communication with another communication terminal in a range of communications.

The drive 61 is provided for reading out various kinds of data, computer programs, and so on stored in attached removal media 70, such as a magnetic disk, an optical disk, a magneto-optic disk, or a semiconductor memory.

According to the embodiment of the present invention as described above, symbol repetition can be characteristically applied to the preamble of a packet generated and the packet can be then transmitted as a wireless signal. Subsequently, the characteristic of the symbol repetition on the packet obtained by receiving the wireless signal and the preamble is then detected based on the characteristic of the detected symbol repetition.

Therefore, an increase in overhead can be prevented as the data of header or payload can be extracted on the reception side even without giving information about symbol repetition performed on the transmission side. In addition, even if there is no sufficient antenna directional gain, the symbol repetition can heighten the gain and stable communication can be thus realized.

The invention should not be construed as being limited to the aforementioned embodiments. The embodiments of the present invention have been described only for illustrative purpose. It is obvious that a person skilled in the art can accomplish correction and substitution of this embodiment without departing from the gist of the present invention. In order to judge the gist of the present invention, the claim should be taken into consideration.

The present application contains subject matter related to that disclosed in Japanese Priority Patent Application JP 2009-104253 filed in the Japan Patent Office on Apr. 22, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A wireless communication apparatus, comprising:
a packet-generating section generating a packet and characteristically performing symbol repetition on a preamble of said packet, and
a transmission section transmitting said packet subjected to said symbol repetition as a wireless signal.

2. The wireless communication apparatus according to claim 1, wherein
said packet-generating section characteristically carries out symbol repetition depending on at least one of the type of the packet and the antenna-directivity pattern.

3. The wireless communication apparatus according to claim 2, wherein
said packet-generating section performs symbol repetition for every symbol or for every predetermined symbol unit.

4. The wireless communication apparatus according to claim 3, wherein
said packet-generating section alters at least any of the number of times of symbol repetition, a symbol amplitude, a symbol phase, and a complex symbol series.

5. The wireless communication apparatus according to claim 1, wherein
said packet-generating section performs characterization of symbol repetition equally performed on two or more of said preamble, and a header and a payload of said packet, when performing said symbol repetition on two or more of them.

6. The wireless communication apparatus according to claim 5, wherein
said packet-generating section performs said symbol repetition in time direction and/or in frequency direction.

7. The wireless communication apparatus according to claim 1, further comprising:
an electric-wave propagation observing section that observes a status of eclectic-wave propagation, wherein
said packet-generating section alters the characteristic of symbol repetition based on an observation result from said electric-wave propagation observing section.

8. The wireless communication apparatus according to claim 7, wherein
said packet-generating section increases the number of times of symbol repetition when said status of eclectic-wave propagation is poor.

9. A wireless communication apparatus, comprising:
a reception section receiving a wireless signal;
a preamble detector detecting a preamble of a packet obtained by receiving said wireless signal received by said reception section; and
a packet processing section extracting data next to the preamble from the packet using a result of said preamble detection, wherein
said preamble detector detects the characteristic of symbol repetition in said packet and then detects said preamble with reference to said detected characteristic of symbol repetition.

10. The wireless communication apparatus according to claim 9, wherein
said preamble detector performs the detection of preamble by calculating a correlation value of symbol repetition in said packet or calculating a correlation value of a predetermined pattern and said packet, and then making a comparison between said calculated correlation value and a predetermined threshold.

11. A wireless communication method, comprising the steps of:
characteristically performing symbol repetition on a preamble of a packet in a packet-generating section; and
transmitting said packet subjected to said symbol repetition as a wireless signal from a transmission section.

12. A wireless communication method, comprising the steps of:
receiving a wireless signal by a reception section;
allowing a preamble detector to detect the characteristic of symbol repetition in a packet obtained by receiving the wireless signal by the reception section, followed by detecting the preamble based on the detected characteristic of the symbol repetition; and
allowing a packet processing section to extract data subsequent the preamble from the packet using the result of the preamble detection.

13. A computer program that allows a computer to execute communication processing on a communication apparatus having a communication section for wireless communication, wherein
said computer is allowed to be functioned as:
means of characteristically performing symbol repetition on a preamble of a packet; and
means of transmitting said packet subjected to said symbol repetition as a wireless signal from said communication section.

14. A computer program that allows a computer to execute communication processing on a communication apparatus having a communication section for wireless communication, wherein
said computer is allowed to be functioned as:
means of receiving a wireless signal by said communication section;
means of detecting the characteristic of symbol repetition in a packet obtained by receiving said wireless signal by said communication section, followed by detecting the preamble based on the detected characteristic of the symbol repetition; and
means of extracting data next to said preamble from said packet using the result of said preamble detection.

15. A wireless communication system, comprising:
a first wireless communication apparatus transmitting a packet; and
a second wireless communication apparatus receiving said packet, wherein
said first wireless communication apparatus includes
a packet-generating section characteristically performing symbol repetition on a preamble of said packet, and
a transmission section transmitting said packet subjected to said symbol repetition as a wireless signal, and
said second wireless communication apparatus includes
a reception section receiving the wireless signal,
a preamble detector detecting the characteristic of symbol repetition in a packet obtained by receiving the wireless signal by the communication section, followed by detecting the preamble based on the detected characteristic of the symbol repetition, and
a packet processing section extracting data next to the preamble from the packet.
